(19) United States
(12) Patent Application Publication
(10) Pub. No.: US 2003/0150120 A1
(43) Pub. Date: Aug. 14, 2003

(54) Toolless blade clamp for reciprocating saw

(76) Inventors: James R. Hartmann, Park Ridge, IL (US); Craig T. Barrett, Schaumburg, IL (US)

Correspondence Address: Victor A. Henzi, Robert Bosch Corporation, 2800 South 25th Avenue, Broadview, IL, 60155-4594, US

(21) Appl. No.: 10/074,391

(22) Filed: Feb. 12, 2002

(51) Int. Cl. B27B 19/00

(52) U.S. Cl. 30/392; 30/329

(57) ABSTRACT

A toolless blade clamp for a reciprocating saw is disclosed comprised of a clamp body that defines a cavity for receiving a saw blade, a wedging member that traverses the cavity, operating means that is coupled with the wedging member and biasing means that acts on the operating means. In a clamping position, the operating means urges the wedging member into contact with an edge of a saw blade to securely clamp it within the cavity. In a releasing position, the operating means is manually urged by the user to bring the wedging member free of the cavity to allow insertion or removal of the saw blade.

### BACKGROUND OF THE INVENTION

The present invention relates to means for attaching saw blades to power tools, and in particular to a device that can secure blades of various designs and thicknesses to the driving member of a reciprocating saw.

The frictional forces encountered by saw blades used in reciprocating tools such as scroll saws, jigsaws or saber saws necessitate a secure blade clamping mechanism. Early blade clamp designs required the use of an additional tool for securing the blade and placed limitations on the shape or features of compatible saw blades. Subsequently, various improvements in this area have focused on simplifying blade mounting and removal and increasing the saw blade compatibility while maintaining a secure clamp. Still many of these designs suffer from problems such as insufficient clamping strength, requirement for excessive user force, complexity in design and manufacture, and limitations on the shape of compatible saw blades.

### BRIEF SUMMARY OF THE INVENTION

It is an object of this invention to describe the design of a blade clamp of simple construction that is compatible with and readily mounted to a variety of reciprocating saws.

It is a further object of this invention that this blade clamp provides a secure clamping mechanism yet permits rapid, toolless mounting of saw blades while maintaining compatibility with multiple blade designs.

It is a further object of this invention to describe a blade clamp body comprising all of the elements necessary to secure a blade, such that the design can function apart from and be refined independently of other features or mounting means such as the driving member of a reciprocating tool.

These objects are achieved by providing a design wherein the operating means for securing and releasing the blade are one in the same. A wedging member is coupled with a spring-biased operating means such that in the rest state, the operating means urges the wedging member into a clamping position. The user may readily handle the operating means to overcome the biasing force thereby directly moving the wedging member, allowing insertion or removal of a saw blade.

The blade-receiving cavity is designed such that a multitude of blade shapes and thicknesses can be accommodated. Blade mounting is intuitive and can be performed quickly and easily without compromising clamping strength.

### BRIEF DESCRIPTION OF THE DRAWINGS

A better understanding of the invention, and of the various embodiments thereof, may be derived from the following description and the accompanying drawings in which:

FIG. 1 is a schematic representation of a jigsaw incorporating the first embodiment of the invention.

FIG. 2 is a longitudinal cross-sectional view of just the blade clamp body of the first embodiment.

FIG. 3 is a perspective view of two saw blades mountable in the present invention.

FIG. 4 is a cross-sectional view of the first embodiment of the blade clamp in the rest state.

FIG. 5 is a side view of the functional end of the blade clamp with a blade in the clamping position. Certain features of the invention and the saw blade not visible in this view are identified by dashed lines to indicate their position relative to the visible features.

FIG. 6 is a perspective view of the first embodiment of this invention. In a like fashion to the previous figure, a feature of the invention, in this case the general outline of the clamp body 12, is identified by dashed lines.

FIG. 7 is a longitudinal cross-sectional view of the first embodiment of the blade clamp in the releasing position. The plane visualized is located laterally with respect to and parallel to the plane of symmetry.

FIG. 8 is a perspective view of a cross-section of the blade clamp body and driving member of the second embodiment of this invention.

FIG. 9 is a cross-sectional view of the blade clamp body and the wedging member of the second embodiment.

FIG. 10 is a perspective view of the second embodiment of the invention in the clamping position with a mounted saw blade and fastened to the driving member.

### DETAILED DESCRIPTION OF THE INVENTION

The present invention is applicable to reciprocating saws in general, including those commonly known as jigsaws, saber saws, or scroll saws. A schematic version of a jigsaw 2 is pictured in FIG. 1 exemplifying the common elements of these saws, which generally include an operator handle 4, a driving member 6 and a housing 8. The housing 8 contains a motor and a gear for driving the reciprocating movement of the driving member 6. A blade clamp, shown generally as 10, may be fastened to the driving member 6 using any of a variety of methods well-known in the art. Alternatively, the driving member 6 and blade clamp 10 may comprise a single contiguous entity.

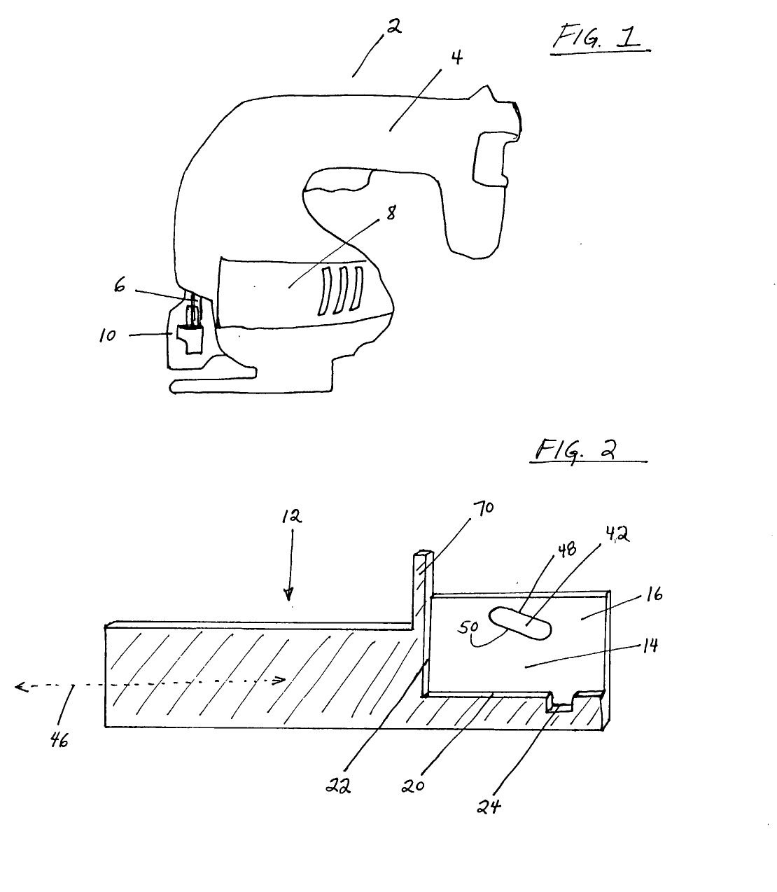

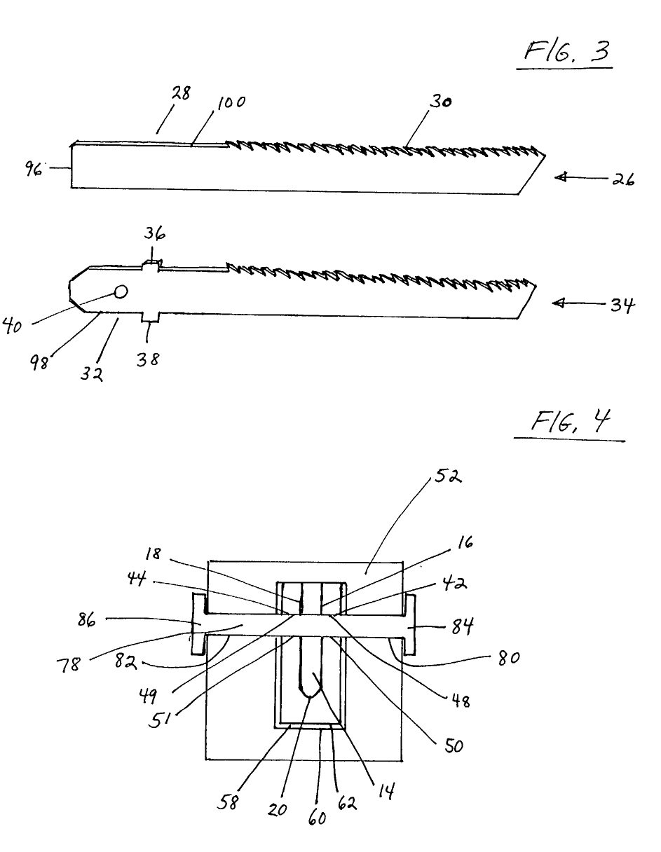

Cross-sectional views of a clamp body 12 of a first embodiment of the blade clamp 10 are shown in FIGS. 2 and 4, revealing a blade-receiving cavity 14 which is defined by two parallel side faces 16 and 18, a grooved longitudinal face 20 and an abutment 22. The spacing between the two side faces 16 and 18 permits mounting of blades of various thickness. A generally V-shaped groove runs along the entire length of the grooved longitudinal face 20. Optionally, the grooved longitudinal face 20 may be further characterized by a notch 24 which may be generally rectangular in shape as shown in FIG. 2.

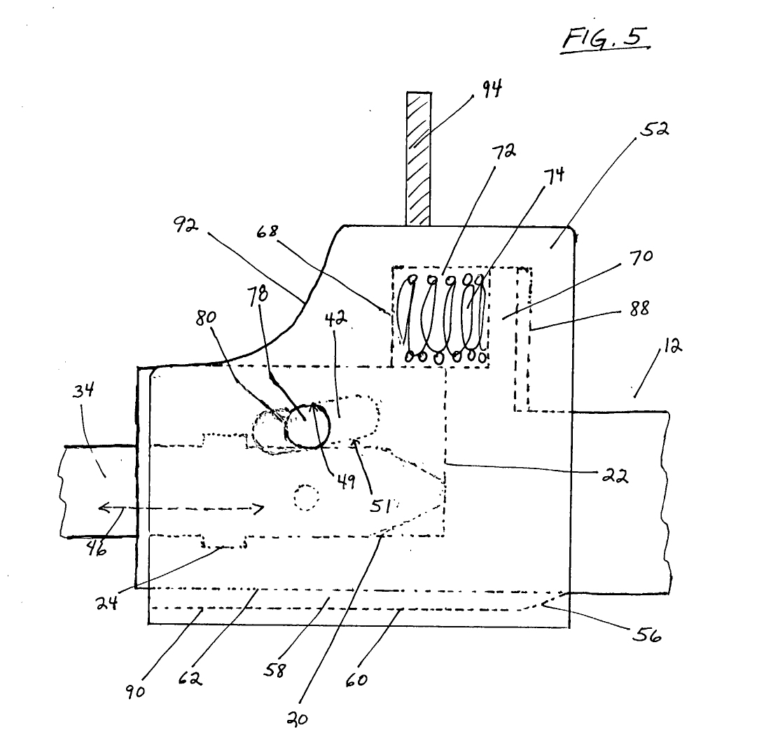

Two examples of reciprocating saw blades compatible with this blade clamp design are illustrated in FIG. 3. A first blade 26 has a generally rectangular mounting portion 28 and a region bearing cutting teeth 30. A generally rectangular mounting portion 32 of a second blade 34 has rectangular lateral extensions 36 and 38, one of which is receivable by the notch 24 when the blade 34 is inserted into the cavity 14. Additional blade features such as an aperture 40 are not relevant to the mounting or clamping of the blade 34 to the blade clamp 10.

In this embodiment (as shown in FIGS. 2, 4 and 5), slots 42 and 44 pass through the side faces 16 and 18 respectively and are slanted with respect to a longitudinal axis 46 of the clamp body 12 forming first inclined surfaces 48 and 49 and second inclined surfaces 50 and 51.

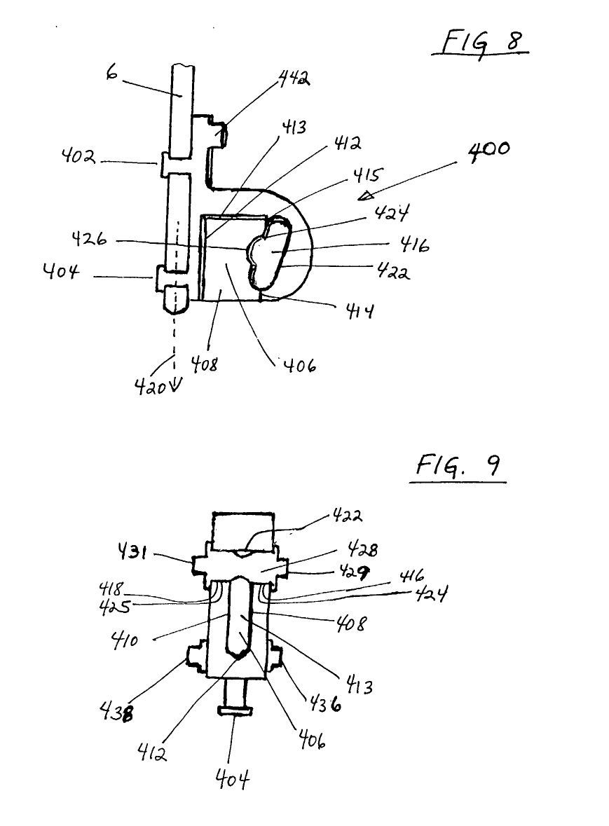

As shown most clearly in FIGS. 4, 5 and 6, a sleeve 52 surrounds the blade-receiving portion of the clamp body 12 in close proximity but freely movable generally along the longitudinal axis 46. An angled protrusion 56 of the sleeve 52 (best visualized in FIG. 5) creates a rear cavity 58 between a rear internal face 60 of the sleeve 52 and a rear face 62 of the clamp body 12. This cavity 58 permits nonlinear movement of the sleeve 52 with respect to the long axis 46 of the clamp body, as seen in FIG. 7 and described below. An equivalent functionality would be provided for if either the rear face 62 or the rear internal face 60 were inclined with respect to this long axis 46 in the region that the sleeve 52 straddles the clamp body 12. A first internal abutment 68 of the sleeve 52 cooperates with a protruding abutment 70 of the clamp body 12 to create a front cavity 72. A biasing means, such as a coil spring 74 or alternatively a globule of elastomeric material 76 is positioned in the front cavity 72 and tends to move the sleeve 52 along the longitudinal axis 46 away from the driving member 6.

Clamping of a saw blade 26 into the blade-receiving cavity 14 is accomplished by a wedging member, in this case a cylindrically-shaped pin 78, passing through the slots 42 and 44 as well as through paired apertures 80 and 82 in the sleeve 52. The pin 78 is preferably maintained within the apertures 80 and 82 using disc-shaped extensions 84 and 86 (see FIG. 4), such attachment permitting free rotation of the pin 78.

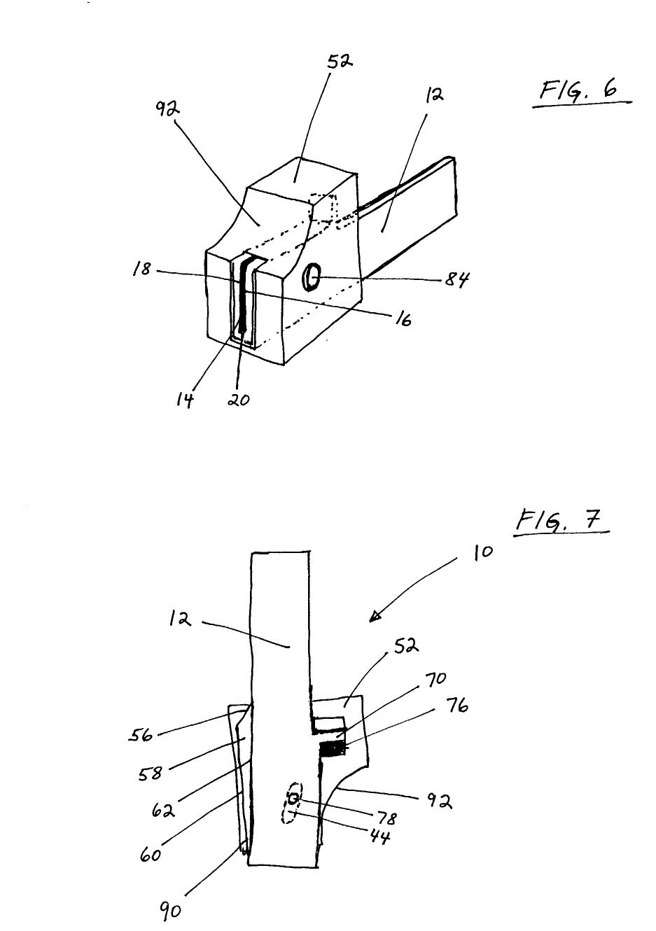

In a rest position of the blade clamp 10 pictured in FIG. 6, the sleeve 52 which is freely slidable along the clamp body 12 has been moved by the spring 74 until a second internal abutment 88 (see FIG. 5) of the sleeve 52 comes into contact with the protruding abutment 70 of the clamp body 12.

To mount a blade, the sleeve 52 is moved against the force of the spring 74 or elastomeric material 76 as illustrated in FIG. 7. With respect to the longitudinal axis 46, the pin 78 is thereby moved axially towards the abutment 22. At the same time, it is biased away from the grooved longitudinal face 20 by the second inclined surfaces 50 and 51, enlarging the available access to the blade-receiving cavity 14. The sleeve 52 moves primarily axially as well, but a front portion 90 of the rear internal face 60 is also driven towards rear face 62 of the clamp body 12 (see FIG. 7). Movement of the sleeve 52 may be facilitated by an arcuate surface 92 on the sleeve 52 suited for manual manipulation by a user of the blade clamp 10. Alternatively the sleeve may include a manually gripable element 94 to serve the same purpose as schematically illustrated in FIG. 5.

In a releasing position of the blade clamp 10 pictured in FIG. 7, the operator may insert the mounting portion 28 of a saw blade 26 into the cavity 14 bringing a top edge 96 of the blade into contact with the abutment 22. A saw blade 34 with rectangular extensions 36 and 38 of the proper dimensions will be received by the notch 24 in the blade-receiving cavity 14, allowing a first edge 98 of the blade 34 to rest against the grooved longitudinal face 20. A saw blade without extensions 26 is similarly inserted into the cavity 14 until it rests against the abutment 22 and grooved longitudinal face 20. Either blade type tends to be centered with respect to the blade receiving cavity 14 when it is received by the grooved longitudinal face 20.

Once the user withdraws the force acting against the spring 74, the sleeve 52 moves generally along the longitudinal axis 46. As a result, the pin 78 is urged into contact with the second edge 100 of the saw blade 26 by the first inclined surfaces 48 and 49, thereby securely wedging the blade against the grooved longitudinal face 20. This state (see FIG. 5) is considered the clamping position.

Such wedging action by the pin 78 provides a secure clamping action. During the downstroke of reciprocation by the driving member 6, the blade 26 is driven into and its movement prohibited by the abutment 22. During the upstroke, even as frictional forces tend to pull the blade out of the cavity 14, the friction of the pin 78 on the blade 26 will tend to move the pin 78 along the first inclined surfaces 48 and 49, thereby increasing the clamping force on the saw blade 26. Use of a saw blade 34 with lateral extensions 36 and 38 provides additional clamping security.

A second and preferred embodiment of the blade clamp is pictured in FIG. 810. In this case, a clamp body 400 includes means 402 and 404 for attaching to the driving member 6, although the clamp body 400 and driving member 6 may also be contiguous. As in the first embodiment, a blade-receiving cavity 406 is defined by two side faces 408 and 410, a grooved longitudinal face 412, and an abutment 413, which may optionally be grooved or partially grooved. However, the blade-receiving cavity 406 is partially defined by parallel second and third longitudinal faces 414 and 415. In addition, the blade-receiving cavity 406 is configured to receive less of the mounting portion 32 of an inserted blade 34. As a consequence, saw blade 34 is compatible with this blade-receiving cavity 406 since the rectangular lateral extensions 36 and 38 of saw blade 34 do not enter the blade-receiving cavity 406 when the mounting portion 32 is mounted so as to come in contact with the abutment 413.

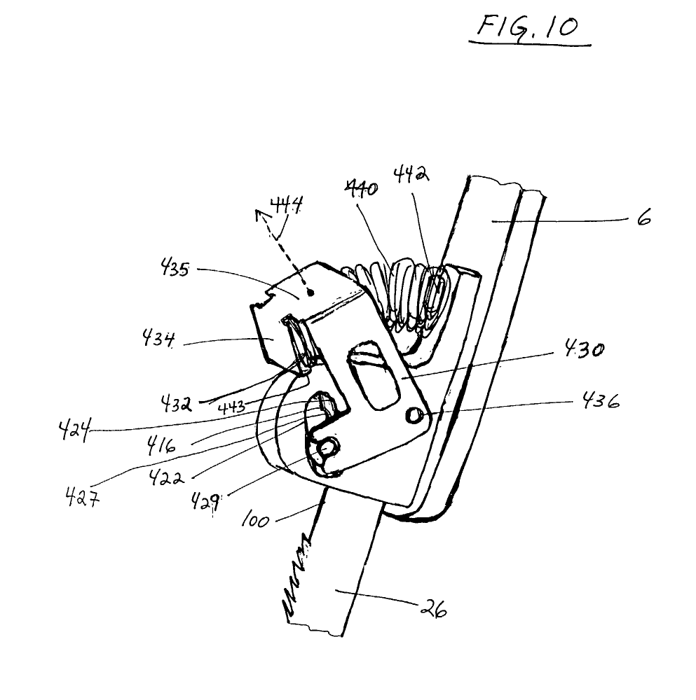

Slots 416 and 418 pass through the side faces 408 and 410 respectively and are inclined with respect to a longitudinal axis 420 of the the clamp body 400 forming first inclined surface 422 plus second inclined surfaces 424 and 425. The second inclined surfaces 424 and 425 may optionally be interrupted by curved openings 426 and 427 (see FIGS. 8 and 10) which facilitate assembly of the invention by allowing insertion of a wedging member 428. The wedging member 428 passes through the slots 416 and 418 as seen in FIG. 9. Like the grooved longitudinal face 412 or optionally the abutment 413, the wedging member 428 may be circumferentially grooved as an additional means to center an inserted blade within the blade-receiving cavity 406. The protruding ends 429 and 431 of the wedging member 428 incorporate a disc shape to retain the wedging member 428 within the clamp body 400 and allow it to freely rotate about its axis of symmetry. The optional curved openings 426 and 427 are fashioned such that the disc-shaped aspects of the wedging member 428 may pass through the slots 416 and 418 during assembly.

The function mediated by the sleeve 52 in the first embodiment is carried out by two L-shaped levers 430 and 432 which straddle the clamp body 400 and are physically linked at one extremity by a joining element with a front aspect 434 and a top aspect 435. The other extremity of each lever may be fork-shaped (as in FIG. 10) or rather have an elongate slot (not pictured) so as to fit about the protruding ends 429 and 431 of the wedging member 428. The levers 430 and 432 are secured to and free to pivot about two protrusions 436 and 438 that pass through cavities in the corners of each lever. This pivot point lends the user a mechanical advantage when manipulating the front aspect of the joining element 434 to move the wedging member 428 during the mounting or releasing of a blade. The extremities of the L-shaped levers are designed with either a fork shape or an elongate slot so that the lever may freely rotate while coupled to the wedging member 428 even though the arc of rotation is not consistent with the linear path of travel of the wedging member 428 through the slots 416 and 418.

Free rotation of the levers 430 and 432 is influenced by a biasing means, in this case a coil spring 440, that is secured between a cylindrical element 442 on the clamp body 400 and the front aspect of the joining element 434 (see FIG. 10) which functions similarly to the internal abutment 68 of the sleeve 52 of the first embodiment. This front aspect 434 may include a lip 443 to further secure the coil spring 440. The coil spring 440 is retained in place by mating with the cylindrical element 442 which is shaped such that it can protrude into the interior of the coil spring 440 itself. Elastomeric material, if it were used in place of a coil spring, is ideally configured to mate with the cylindrical element 442 as well. The coil spring 440 acts on the joining element to pivot the levers such that the acute angle between the long axis 444 of levers 430 and 432 and the long axis 420 of the clamp body 400 is increased. In a manner similar to the sleeve 52 of the first embodiment, the biasing action of the spring 440 has the effect of causing the forked regions of the levers 430 and 432 to urge the wedging member 428 to move within the inclined slots 416 and 418 such that the wedging member 428 is driven towards the grooved longitudinal face 412 and away from the abutment 413.

To mount a saw blade 26 or 34, a user presses the front aspect of the joining element 434 to directly counteract the force of the coil spring 440 on the levers 430 and 432. The forked region of each lever urges the wedging member 428 to move within the inclined slots 416 and 418, thereby freeing up the blade-receiving cavity 406. After inserting a saw blade 26 or 34, releasing the force on the front aspect of the joining element 434 allows the coil spring to rotate the levers 430 and 432 such that the wedging member 428 is pressed by the first inclined surface 422 into the second edge 100 of the mounted saw blade 26 or 34. In a like fashion to the first embodiment, this provides a secure clamping action.

The invention is not intended to be limited to the particular embodiments shown, but rather to include such alternatives, modifications and equivalents as one skilled in the art would appreciate to be within the spirit and scope of the invention as described by the appended claims

What is claimed is:

1. A blade clamp for a reciprocating tool comprising
a clamp body that defines a cavity for receiving a mounting portion of a saw blade, said cavity partially defined by a longitudinal face extending substantially parallel to an intended direction of reciprocation of said clamp body and an inclined surface that is slanted with respect to and opposite said longitudinal face;
a wedging member that traverses said cavity and is movable along said inclined surface;
operating means that is disposed about at least a portion of and movable with respect to said clamp body and physically coupled with said wedging member for urging the wedging member into a releasing position to allow a saw blade to be inserted into or removed from said cavity; and
biasing means for urging said operating means into a clamping position which brings said wedging member into a clamping engagement with a saw blade inserted into said cavity.

2. The blade clamp as set forth in claim 1, additionally comprising means for attaching said clamp body to the driving member of a reciprocating tool.

3. The blade clamp as set forth in claim 1, wherein said clamp body is formed integral with a driving member of a reciprocating tool.

4. The blade clamp set forth in claim 1, additionally comprising a notch in said longitudinal face

5. The blade clamp as set forth in claim 1, wherein said operating means includes a manually-operable surface to facilitate the urging of the operating means into said releasing position.

6. The blade clamp as set forth in claim 1, further comprising a manually gripable element mounted to said operating means to facilitate the urging of the operating means into said releasing position.

7. The blade clamp as set forth in claim 1, wherein said longitudinal face is grooved along its length.

8. The blade clamp as set forth in claim 1, wherein said cavity is further defined by an abutment that limits the extent that a saw blade may be inserted.

9. The blade clamp as set forth in claim 8, wherein said abutment is at least partially grooved along its length.

10. The blade clamp as set forth in claim 1, wherein said wedging member is coupled to the operating means by means that allow the wedging member to freely rotate about its axis of symmetry.

11. The blade clamp as set forth in claim 1, wherein said biasing means is oriented between an abutment on said clamp body and an internal abutment within said operating means.

12. The blade clamp as set forth in claim 11, wherein said biasing means is a coil spring.

13. The blade clamp as set forth in claim 11, wherein said biasing means is a globule of elastomeric material.

14. A reciprocating tool comprising
a driving member;
a blade clamp configured at the end of said drive member; said blade clamp comprising
a clamp body that defines a cavity for receiving a mounting portion of a saw blade, said cavity partially defined by a longitudinal face extending substantially parallel to an intended direction of reciprocation of said clamp body and an inclined surface that is slanted with respect to and opposite said longitudinal face;
a wedging member that traverses said cavity and is movable along said inclined surface;
operating means that is disposed about at least a portion of and movable with respect to said clamp body and physically coupled with said wedging member for urging the wedging member into a releasing position to allow a saw blade to be inserted into or removed from said cavity; and
biasing means for urging said operating means into a clamping position which brings said wedging member into a clamping engagement with a saw blade inserted into said cavity.
